(19) United States
(12) Patent Application Publication
(10) Pub. No.: US 2026/0291816 A1
(43) Pub. Date: Sep. 24, 2026

(54) MANAGING FATE SHARING BETWEEN OVERLAY NETWORKS AND UNDERLAY NETWORKS

(71) Applicant: Cisco Technology, Inc., San Jose, CA (US)

(72) Inventors: Jerome HENRY, Pittsboro, NC (US); Elango GANESAN, Portola Valley, CA (US); Priyanka BANSAL, Bengaluru (IN); Robert E. BARTON, Richmond (CA); Saravanan M. KARUNANIDHI, Bangalore (IN); Srinivasa Rao NALLURI, Akshaya Nagar East (IN)

(21) Appl. No.: 19/084,260

(22) Filed: Mar. 19, 2025

(51) Int. Cl. H04L 41/122; H04L 1/22; H04L 12/437; H04L 41/22; H04L 43/045

(52) U.S. Cl. CPC H04L 41/122; H04L 1/22; H04L 12/437; H04L 41/22; H04L 43/045

(57) ABSTRACT

In one embodiment, an illustrative method herein may comprise: determining, by a device, an underlay network physical topology; determining, by the device, an overlay network virtual topology in relation to the underlay network physical topology; determining, by the device, an intent for redundancy between a replication ingress point to a replication egress point within the overlay network virtual topology; and computing, by the device, a plurality of disjoint overlay paths from the replication ingress point to the replication egress point, ensuring that each of the plurality of disjoint overlay paths do not share any portion of the underlay network physical topology.

### TECHNICAL FIELD

The present disclosure relates generally to computer networks, and, more particularly, to managing fate sharing between overlay networks and underlay networks.

### BACKGROUND

Many modern Operational Technology (OT) applications like those used in manufacturing, energy, transportation, and critical infrastructure, often require strict real-time communication with minimal delay or data loss and cannot tolerate the loss of even a single packet (e.g., IEC 61850 sampled values, etc.). To ensure no disruption occurs on the network, OT resiliency techniques such as Parallel Redundancy Protocol (PRP) and High-availability Seamless Redundancy (HSR) are used. These techniques leverage frame replication either at the source, or a network node near the source (known as a redundancy box or “RedBox”) where the duplicate frames are sent on two independent paths (e.g., local area network (LAN) segments). At the receiving end, the first frame that arrives is forwarded on, while the duplicate is dropped when it arrives.

PRP implements redundancy by using PRP-enabled nodes (Industrial Automation and Control Systems or “IACS” devices) that send duplicate Ethernet frames to two independent networks. HSR solves a similar problem by providing zero-delay recovery in network communications by sending duplicate frames over two separate paths, ensuring continuous data delivery even if one path fails. While effective, both of these two solutions are limited, based solely on virtual topologies of overlay networks.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates an example of underlay and overlay networks;

FIG. 4 illustrates an example of computing disjoint redundancy paths based on both overlay networks and underlay networks;

FIG. 5 illustrates an example of single fate avoidance options; and

FIG. 6 illustrates an example procedure for managing fate sharing between overlay networks and underlay networks in accordance with one or more embodiments described herein.

### DESCRIPTION OF EXAMPLE EMBODIMENTS

### Overview

According to one or more embodiments of the disclosure, an illustrative method herein may comprise: determining, by a device, an underlay network physical topology; determining, by the device, an overlay network virtual topology in relation to the underlay network physical topology; determining, by the device, an intent for redundancy between a replication ingress point to a replication egress point within the overlay network virtual topology; and computing, by the device, a plurality of disjoint overlay paths from the replication ingress point to the replication egress point, ensuring that each of the plurality of disjoint overlay paths do not share any portion of the underlay network physical topology.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

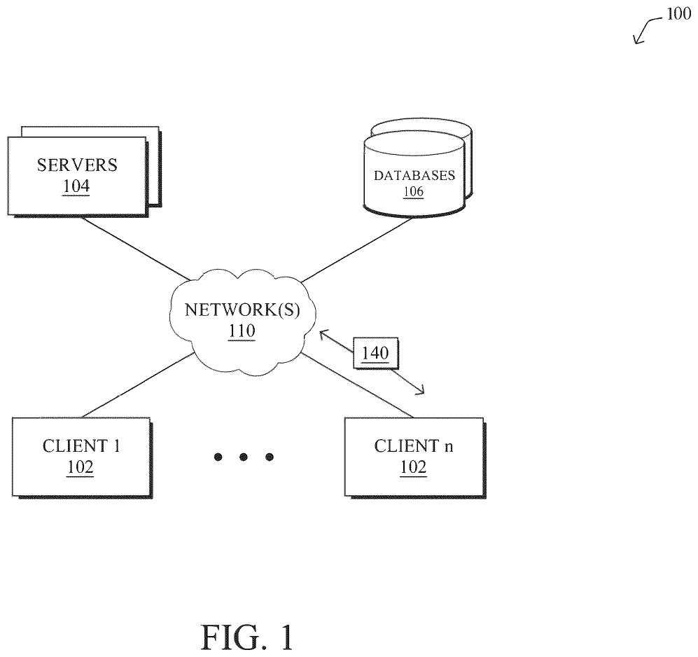

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Network(s) 110 may include, for example, network backbones or other internetworking systems, and may include various customer edge (CE) routers interconnected with provider edge (PE) routers in order to communicate across a core network to provide connectivity between devices which may be located in different geographical areas and/or on different types of local networks (e.g., local/branch networks versus data center/cloud environments). For example, these routers may be interconnected by the public Internet, a multiprotocol label switching (MPLS) virtual private network (VPN), or the like. In some implementations, a router or a set of routers may be connected to a private network (e.g., dedicated leased lines, an optical network, etc.) or a VPN (e.g., MPLS VPN) thanks to a carrier network, via one or more links exhibiting different network and service level agreement characteristics.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art. Servers 104, for example, may be configured as a network controller/supervisory service located in a data center with databases 106, accordingly. For instance, servers 104 may include, in various implementations, a network management server (NMS), a dynamic host configuration protocol (DHCP) server, a constrained application protocol (CoAP) server, an outage management system (OMS), an application policy infrastructure controller (APIC), an application server, etc.

Those skilled in the art will also understand that any number of nodes, devices, links, etc. may be used in computing system 100, and that the view shown herein is for simplicity. As would also be appreciated, computing system 100 may include any number of local networks, data centers, cloud environments, devices/nodes, servers, etc. Also, those skilled in the art will further understand that while the network is shown in a certain orientation, the computing system 100 is merely an example illustration that is not meant to limit the disclosure.

For instance, smart object networks, such as sensor networks, in particular, are a specific type of network (e.g., computing system 100) having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Generally, size and cost constraints on smart object nodes (e.g., sensors) result in corresponding constraints on resources such as energy, memory, computational speed and bandwidth.

In some implementations, the techniques herein may be applied to still other network topologies and configurations. For example, the techniques herein may be applied to peering points with high-speed links, data centers, etc.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

According to various implementations, a software-defined WAN (SD-WAN) may be used in computing system 100 to connect local networks and data center/cloud environments. In general, an SD-WAN uses a software defined networking (SDN)-based approach to instantiate tunnels on top of the physical network and control routing decisions, accordingly. For example, one tunnel may connect a customer edge (CE) router at the edge of a local network to router a remote CE router at the edge of a data center/cloud environment over an MPLS or Internet-based service provider network in a network backbone. Similarly, a second tunnel may also connect these routers over a 4G/5G/LTE cellular service provider network. SD-WAN techniques allow the WAN functions to be virtualized, essentially forming a virtual connection between local networks and data center/cloud environments on top of the various underlying connections. Another feature of SD-WAN is centralized management by a supervisory service that can monitor and adjust the various connections, as needed.

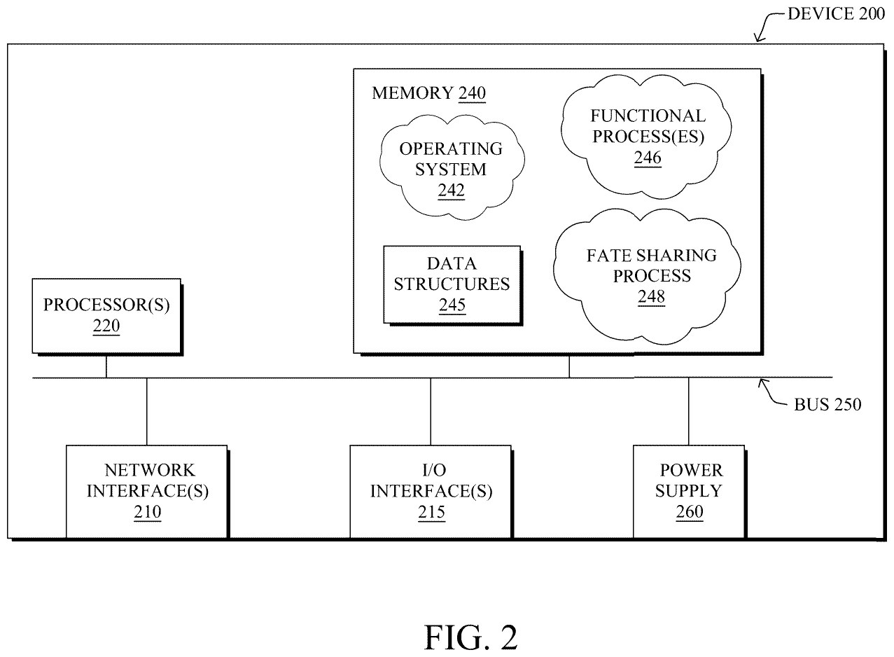

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, a “fate sharing” process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

For instance, one or more functional processes 246 may include computer executable instructions executed by the processor(s) 220 to perform routing functions in conjunction with one or more routing protocols. These functions may, on capable devices, be configured to manage a routing/forwarding table (a data structure 245) containing, e.g., data used to make routing/forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (e.g., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, the one or more functional processes 246 may consist solely of providing mechanisms necessary for source routing techniques. That is, for source routing, other devices in the network can tell the less capable devices exactly where to send the packets, and the less capable devices simply forward the packets as directed.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

### Managing Fate Sharing Between Overlay and Underlay Networks

As will be generally understood by those skilled in the art, an “underlay network” is the physical or foundational network infrastructure that supports the operation of one or more “overlay networks”. Underlay networks form the backbone of modern communications and generally consist of hardware devices like routers, switches, and physical connections such as fiber optics, cables, or wireless links. That is, the underlay network handles packet forwarding, routing, and physical data transmission, providing the basic connectivity and transport mechanisms on which higher-level services (overlays) are built. Example underlay networks are things such as LANs, WANs, cellular networks, satellite networks, and so on.

An overlay network is a virtual network that is built on top of an existing physical (underlay) network. Nodes in an overlay network are connected by virtual or logical links that correspond to paths in the underlying physical network. Overlay networks abstract the complexity of the physical network to provide additional functionality, improved scalability, or specialized services. Overlay networks come in various forms, tailored to meet specific needs and functionalities. Examples may include VPNs, Content Delivery Networks (CDNs), Software-Defined Networking (SDN), SD-WAN architectures, cloud-native networking, application-layer overlays, and so on. An overlay layer allows traffic to be routed through virtual network paths rather than relying on physical links, giving administrators the ability to programmatically control and direct traffic flows. That is, overlays make it possible to define and manage traffic patterns independently of the physical network structure.

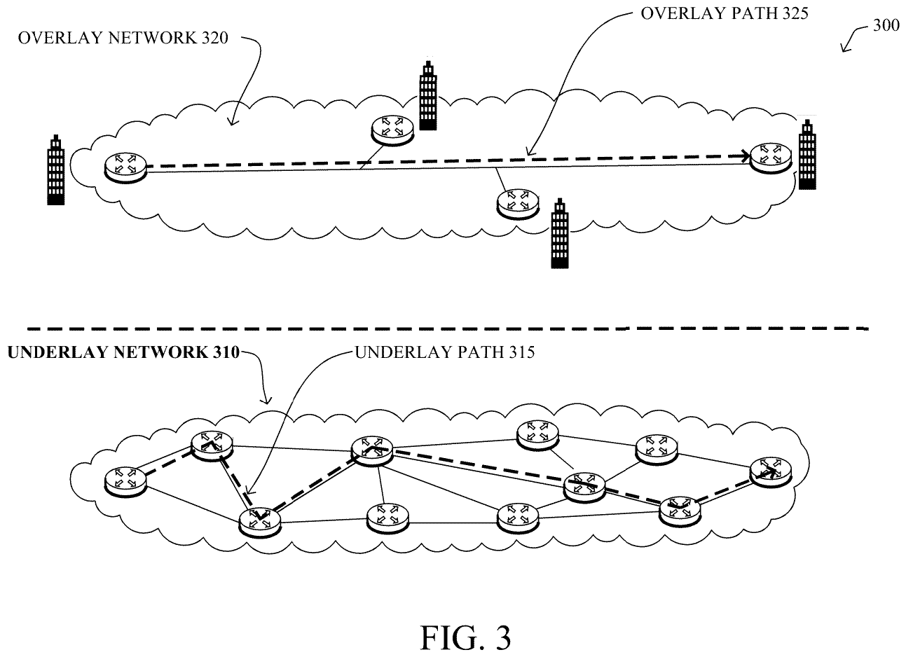

FIG. 3 illustrates a simplified example of a topology 300 comprising an underlay network 310 and an overlay network 320. As shown, the underlay network has a number of network devices, such as routers, switches, firewalls, load balancers, and so on, connected together by physical links as shown. An underlay path 315, for example, traverses physical interconnections through physical devices to traverse the underlay network 310. Conversely, the overlay network may comprise virtual connections such as tunnels or otherwise, resulting in an overlay path 325 between entities across the overlay network 320. As will be appreciated by those skilled in the art, underlay path 315 and overlay path 325 are only different in terms of perspective, and not in terms of actual traffic traversal of those paths through the topology 300.

Notably, the Parallel Redundancy Protocol (PRP) is a fault-tolerant network protocol designed to ensure uninterrupted data transmission by duplicating packets and sending them simultaneously over two independent, parallel networks. It is defined in IEC 62439-3, which focuses on high-availability automation networks. PRP achieves seamless redundancy by allowing end devices, known as Dual Attached Nodes (DANs), to transmit identical packets over both networks. The receiving device uses the first valid packet that arrives and discards the duplicate. This approach ensures zero recovery time in the event of a network failure, thereby making PRP ideal for applications that demand real-time communication and high reliability.

High-Availability Seamless Redundancy (HSR), on the other hand, is a fault-tolerant protocol designed to ensure continuous data transmission in industrial and mission-critical networks. Defined in IEC 62439-3, HSR provides redundancy by employing a ring topology where every node in the network is connected to two adjacent nodes. Data packets are duplicated and transmitted in both directions around the ring. This dual transmission ensures that the recipient node receives at least one copy of the data, even if a failure occurs in one part of the network. Unlike traditional failover mechanisms, HSR offers zero recovery time like PRP above, making it also a highly effective choice for systems that demand uninterrupted real-time communication.

As noted above, in particular, many modern Operational Technology (OT) applications like those used in manufacturing, energy, transportation, and critical infrastructure, often require strict real-time communication with minimal delay or data loss and cannot tolerate the loss of even a single packet (e.g. IEC 61850 sampled values, etc.). To ensure no disruption occurs on the network, OT resiliency techniques such as PRP and HSR are used. As detailed above, these techniques leverage frame replication either at the source, or a network node near the source (known as a redundancy box “RedBox”) where the duplicate frames are sent on two independent pathways (e.g., LAN segments). At the receiving end, the first frame that arrives is forwarded on, while the duplicate is dropped when it arrives.

For OT networks, for instance, PRP implements redundancy by using PRP-enabled nodes (Industrial Automation and Control Systems or “IACS” devices) that send duplicate Ethernet frames to two fail-independent network infrastructures. HSR solves a similar problem by providing zero-delay recovery in network communications by sending duplicate frames over two separate ring-based paths (e.g., each direction in a ring topology), ensuring continuous data delivery even if one path fails. However, these protocols do not validate the network topology for single fate links.

The techniques herein, therefore, are directed to managing fate sharing between overlay networks and underlay networks. For instance, as detailed below, the techniques herein may provide a method to assist a controller when deploying PRP or HSR in an OT overlay fabric network. PRP and HSR inherently require different physical paths for redundancy. However, with a fabric network, the redundant overlay paths may intersect on the same underlay paths causing fate sharing issues. The techniques herein, in particular, thus allow a controller to explore non-overlapping/non-fate sharing overlay paths, allowing compliance with PRP and HSR, ensuring that if there is a disruption on one pathway (e.g., segment), the duplicate frame sent on the other pathway will arrive, allowing the application to continue working.

Specifically, according to one or more embodiments of the disclosure as described in detail below, an illustrative method herein may comprise: determining, by a device, an underlay network physical topology; determining, by the device, an overlay network virtual topology in relation to the underlay network physical topology; determining, by the device, an intent for redundancy between a replication ingress point to a replication egress point within the overlay network virtual topology; and computing, by the device, a plurality of disjoint overlay paths from the replication ingress point to the replication egress point, ensuring that each of the plurality of disjoint overlay paths do not share any portion of the underlay network physical topology.

Operationally, the techniques herein may illustratively be broken down broadly into the following steps:
1. Topology discovery;
2. No Fate Sharing Intent;
3. Path Computation;
4. Visualization and Verification;
5. Path Selection and Installation; and
6. Dynamic Adjustment & Continuous Monitoring.

### Step 1: Topology Discovery:

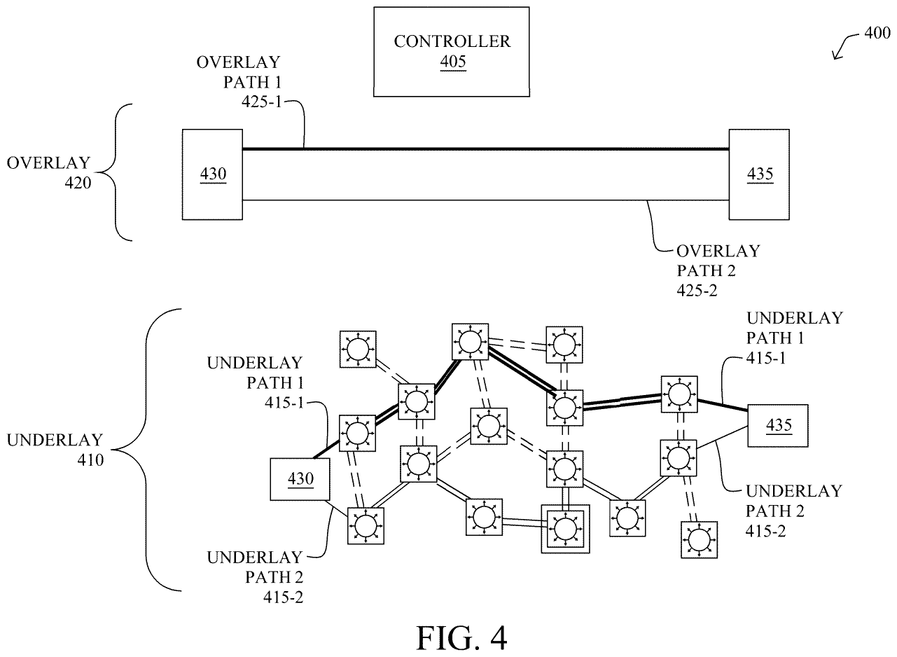

First, and with reference to FIG. 4 illustrating another example simplified computer network topology (topology 400), assume that a given network (e.g., an OT network) may be deployed with a controller 405 supporting an underlay fabric 410 and overlay fabric 420. The controller computes a complete map of the entire network topology, including all underlay nodes and links. This computation may be achieved by using protocols such as Link Layer Discovery Protocol (LLDP), Simple Network Management Protocol (SNMP), or by integrating with a Software-Defined Networking (SDN) controller that has global visibility of the network state.

### Step 2: No Fate Sharing Intent:

An operator (e.g., user, administrator, automated process, AI, etc.) introduces to the controller an intent for redundancy (e.g., PRP or HSR) to be deployed as an overlay on the fabric. The controller 405 will understand that there are specific capability requirements introduced for the use case and will query the operator for certain details. For example, once an intent for PRP or HSR is introduced, the controller may ask for identification of the intended source and destination points where replication/removal of the frames will occur and which nodes will function as RedBoxes. As shown, replication node 430 and removal node 435 may be the source and destination of traffic, or may be intermediate nodes that are between other sources and/or destinations of such traffic, accordingly.

### Step 3: Path Computation:

Having identified the frame replication and removal nodes, the controller uses the topology information to compute two or more (e.g., all possible) disjoint paths (e.g., “LAN A” and “LAN B” for PRP, or “Ring Side A”/“Ring Side B” for HSR) from the replication entry to the exit points (i.e., in this example, replication node 430 and removal node 435, respectively). As shown, a first underlay path “1” (underlay path 415-1) and a second underlay path “2” (underlay pay 415-2) are shown, while the corresponding overlay paths are shown as first overlay path “1” (overlay path 425-1) and a second overlay path “2” (overlay pay 425-2), accordingly.

While computing the paths, the controller must enforce the constraint that the two paths do not share any underlay nodes or links. This means that if one path uses a particular node or link, the other path must use an entirely different set of nodes and links. Computing disjoint paths may be done using algorithms that find disjoint paths, such as: Suurballe's algorithm, Yen's algorithm for k-shortest paths (selecting two shortest non-overlapping paths), or Disjoint shortest path algorithms that are specifically designed to find non-intersecting paths.

Namely, the nodes adjacent to the source point and the destination point (replication node 430 and removal node 435, respectively) become the first and last nodes of the respective paths, e.g., path “A” and path “B”. The rest of the intermediate nodes also need to be disjoint for path A and B. Consider, that is, that point A1 is adjacent to the replication node on LAN A, and A2 is the node adjacent to the destination on the LAN A segment. Similarly B1 and B2 can be nodes on the LAN B segment. This problem can thus be illustrated as a path computation from A1 to A2 and from B1 to B2 that needs to be disjoint, which is a 2-disjoint path problem.

In the case of PRP, each path also needs to ensure that the LAN (e.g., LAN A of path 1, for instance) of the source node connects to the same LAN (e.g., LAN A) of the destination node so that the LANs are not swapped. Similarly in case of HSR, the Ring Side (e.g., Ring Side A of path 1, for instance) of the source must be connected to the same Ring Side (e.g., Ring Side A) of the destination.

### Step 4: Visualization and Verification

Once the two disjoint paths have been calculated, the controller may choose to have a visualization tool that allows network operators to see all the calculated disjoint paths along with the performance metrics associated with each path (e.g. Latency, etc.) for ultimate selection (if more than two options), approval, general knowledge, and so on.

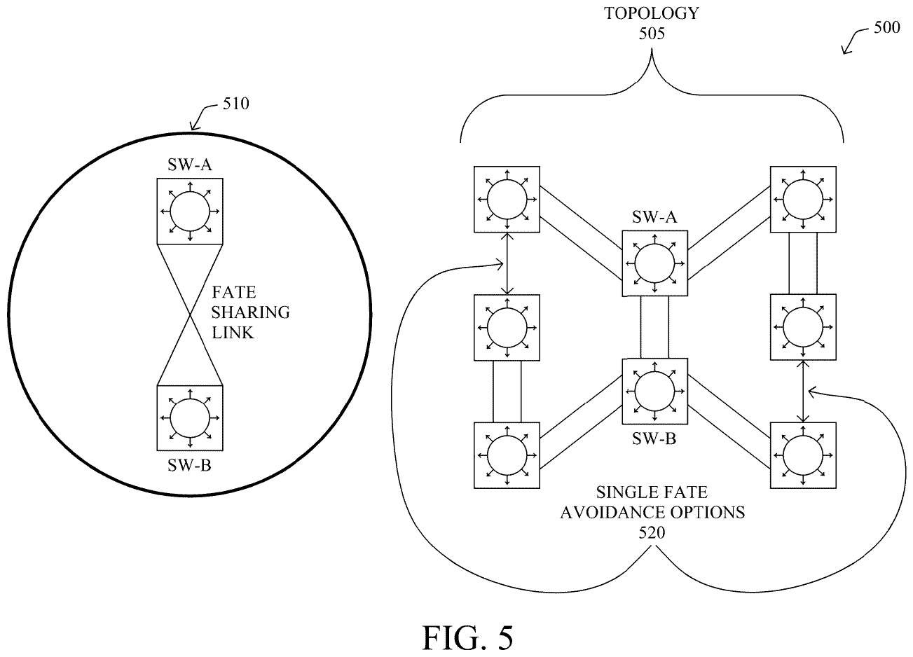

If two independent paths cannot be found, the controller may alert the administrator that a fate sharing scenario exists and the objective of path independence cannot be met as prescribed. FIG. 5 illustrates an example of a visualization 500 that shows a topology 505 (e.g., the entire topology or a selected subset of a larger topology). This visualization may indicate the overlapping or “fate sharing” elements (e.g., nodes, links, etc.), such as in highlight 510 (e.g., the shared link between switches “SW A” and “SW B”). In one embodiment, the techniques herein may also suggest certain “single fate avoidance” options 520, or else an administrator may be able to ascertain how to create such options manually based on the visualization 500, accordingly.

### Step 5: Path Selection and Installation:

The operator (or other controlling entity) may choose the option to continue or abort the deployment in either case. Based on the paths calculated by controller, the operator may choose specific paths based on the requirements of the application. The controller then configures the forwarding rules in the network devices along these paths to ensure that traffic is replicated and transmitted on both routes. These forwarding rules are specific to each of the flows and each node along the path will forward these flows according to these rules.

For instance, according to the techniques described herein, if disjoint paths are found and so configured, PRP or HSR may then be configured to bi-cast duplicate frames along the two different and disjoint paths, ensuring that the overlay paths do not have any overlapping underlay elements, protecting against any fate sharing between the two paths, accordingly.

### Step 6: Dynamic Adjustment & Continuous Monitoring:

In a dynamic network environment, changes such as node/link failures or additions may affect the current paths. According to the techniques herein, the controller may continuously monitor (or periodically check on) the health and status of the installed paths to ensure that the disjoint paths remain operational and independent.

If a failure is detected on one path, the controller can proactively compute a new disjoint path with fate sharing constraints, automatically set up the new path, or/and send an alert to operator to confirm the new path.

Note also that in certain embodiments herein, assume that “path X” and “path Y” are the original paths established and installed, and that a node/link fails in path Y, such that the controller later establishes a new disjoint path, “path Z” (pre-determined or determined on-demand in response to the failure of path Y). Should it be later determined that the failed node/link in path Y has recovered, the controller may then decide whether to return back to path Y after comparing one or more factors between path Y and path Z, such as path cost, Quality of Service (QoS) aspects, difficulty of switching paths, and so on.

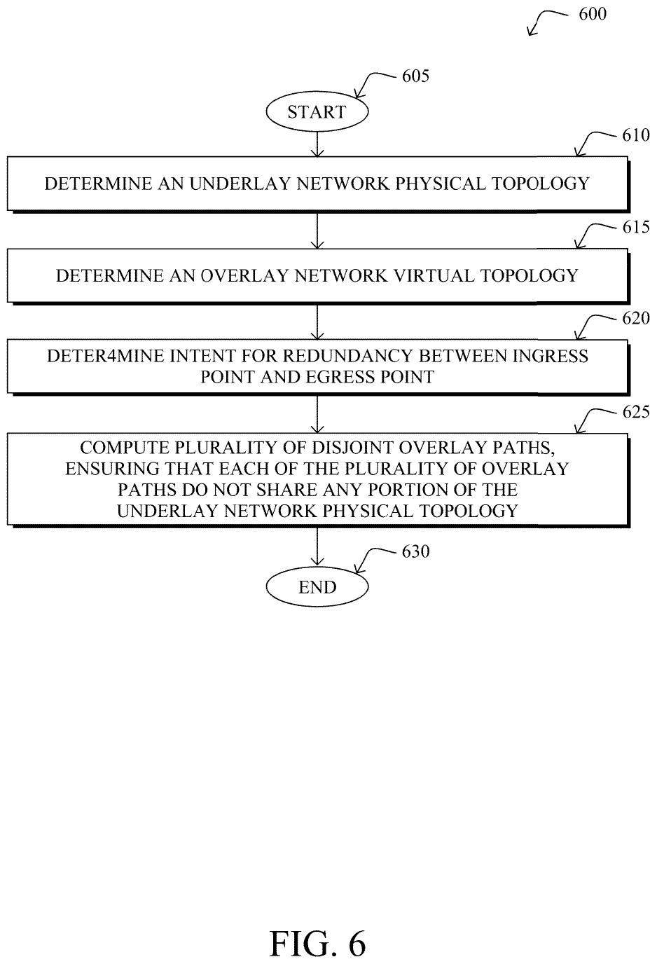

In closing, FIG. 6 illustrates an example simplified procedure for managing fate sharing between overlay networks and underlay networks in accordance with one or more embodiments described herein, particularly from the perspective of a device in control over computation of disjoint redundancy as described herein. For example, a non-generic, specifically configured device (e.g., device 200, an apparatus) may perform procedure 600 by executing stored instructions (e.g., process 248). The procedure 600 may start at step 605, and continue to step 610, where, as described in greater detail above, the device may determine an underlay network physical topology. At step 615, the device may determine an overlay network virtual topology in relation to the underlay network physical topology. In some embodiments, the overlay network virtual topology may comprise two independent local area networks and utilizes a Parallel Redundancy Protocol (PRP). In another embodiment, the overlay network virtual topology may comprise two sides of a ring topology and utilize High-availability Seamless Redundancy (HSR).

At step 620, the device may determine an intent for redundancy between a replication ingress point to a replication egress point within the overlay network virtual topology. In some embodiments, the replication ingress point of a first ring side of the two sides of the ring topology may connect with the first ring side at the replication egress point.

At step 625, the device may compute a plurality of disjoint overlay paths from the replication ingress point to the replication egress point, ensuring that each of the plurality of overlay paths do not share any portion of the underlay network physical topology. Additionally, in another embodiment, the device ensures that the replication ingress point of a first local area network of the two independent local area networks connects with the first local area network at the replication egress point. In another embodiment, the device may determine an inability to find two disjoint overlay paths and generate (in response to the inability to find two disjoint overlay paths) a notification indicating the inability to find two disjoint overlay paths and one or more locations of required overlap.

In some embodiments, the device may provide a graphical virtualization of the plurality of disjoint overlay paths. Additionally, in other embodiments, the device may provide performance metrics of the plurality of disjoint overlay paths on the graphical virtualization.

In another embodiment, the device may configure forwarding rules to ensure that traffic complies with the plurality of disjoint overlay paths. Additionally, in other embodiments, the device may require administrator approval prior to configuring the forwarding rules. In a further embodiment, the device may request identification of the replication ingress point and the replication egress point in response to determining the intent for redundancy.

In some embodiments, the device may determine a change to one or both of the underlay network physical topology or the overlay network virtual topology and confirm (in response to determining the change), a continued plurality of disjoint overlay paths from the replication ingress point to the replication egress point after the change. In a further embodiment, the device may compute a plurality of disjoint overlay paths that have substantially similar traffic timing characteristics for transmission of traffic between the replication ingress point and the replication egress point. In another embodiment, the device may compute a plurality of disjoint overlay paths that are computed specifically to be node disjoint, link disjoint, or node and link disjoint.

Procedure 600 then ends at step 630.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In some implementations, an illustrative apparatus herein may comprise: one or more network interfaces to communicate with a network; a processor coupled to the one or more network interfaces and configured to execute one or more processes; and a memory configured to store a process that is executable by the processor, the process comprising: determining an underlay network physical topology, and further determining an overlay network virtual topology in relation to the underlay network physical topology. The process may further determine an intent for redundancy between a replication ingress point to a replication egress point within the overlay network virtual topology. The process may also compute, a plurality of disjoint overlay paths from the replication ingress point to the replication egress point, ensuring that each of the plurality of disjoint overlay paths do not share any portion of the underlay network physical topology.

In still other implementations, a tangible, non-transitory, computer-readable medium storing program instructions that cause a device to execute a process comprising: determining an underlay network physical topology, and further determining an overlay network virtual topology in relation to the underlay network physical topology. The process may further determine an intent for redundancy between a replication ingress point to a replication egress point within the overlay network virtual topology. The process may also compute, a plurality of disjoint overlay paths from the replication ingress point to the replication egress point, ensuring that each of the plurality of disjoint overlay paths do not share any portion of the underlay network physical topology.

The techniques described herein, therefore, provide for managing fate sharing between overlay networks and underlay networks. Effective management of fate sharing between overlay and underlay networks enhances network reliability, resiliency, and efficiency. By aligning the failure and recovery mechanisms of the overlay network while ensuring truly disjoint underlay pathways, the techniques herein ensure that disruptions and downtime are reduced by mitigating the impact of both overlay and underlay failures. That is, by optimizing coordination between overlay and underlay networks, the system enhances service continuity, particularly in dynamic and high-availability environments such as multi-cloud deployments, software-defined networking (SDN) architectures, and real-time communication systems.

Illustratively, the techniques described herein may be performed by hardware, software, and/or firmware, (e.g., an “apparatus”) such as in accordance with the fate sharing process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
determining, by a device, an underlay network physical topology;
determining, by the device, an overlay network virtual topology in relation to the underlay network physical topology;
determining, by the device, an intent for redundancy between a replication ingress point to a replication egress point within the overlay network virtual topology; and
computing, by the device, a plurality of disjoint overlay paths from the replication ingress point to the replication egress point, ensuring that each of the plurality of disjoint overlay paths do not share any portion of the underlay network physical topology.

2. The method as in claim 1, wherein the overlay network virtual topology comprises two independent local area networks and utilizes a Parallel Redundancy Protocol (PRP).

3. The method as in claim 2, further comprising:
ensuring that the replication ingress point of a first local area network of the two independent local area networks connects with the first local area network at the replication egress point.

4. The method as in claim 1, wherein the overlay network virtual topology comprises two sides of a ring topology and utilizes High-availability Seamless Redundancy (HSR).

5. The method as in claim 4, wherein the replication ingress point of a first ring side of the two sides of the ring topology connects with the first ring side at the replication egress point.

6. The method as in claim 1, further comprising:
determining an inability to find two disjoint overlay paths; and
generating, in response to the inability to find two disjoint overlay paths a notification indicating the inability to find two disjoint overlay paths and one or more locations of required overlap.

7. The method as in claim 1, further comprising:
providing a graphical virtualization of the plurality of disjoint overlay paths.

8. The method as in claim 7, further comprising:
providing performance metrics of the plurality of disjoint overlay paths on the graphical virtualization.

9. The method as in claim 1, further comprising:
configuring forwarding rules to ensure that traffic complies with the plurality of disjoint overlay paths.

10. The method as in claim 9, further comprising:
requiring administrator approval prior to configuring the forwarding rules.

11. The method as in claim 9, further comprising:
configuring the forwarding rules autonomously in response to a particular flow requesting redundancy.

12. The method as in claim 1, further comprising:
requesting identification of the replication ingress point and the replication egress point in response to determining the intent for redundancy.

13. The method as in claim 1, further comprising:
determining a change to one or both of the underlay network physical topology or the overlay network virtual topology; and
confirming, in response to determining the change, a continued plurality of disjoint overlay paths from the replication ingress point to the replication egress point after the change.

14. The method as in claim 1, wherein the plurality of disjoint overlay paths have substantially similar traffic timing characteristics for transmission of traffic between the replication ingress point and the replication egress point.

15. The method as in claim 1, wherein the plurality of disjoint overlay paths are computed specifically to be node disjoint, link disjoint, or node and link disjoint.

16. An apparatus, comprising:
one or more network interfaces;
a processor coupled to the one or more network interfaces and configured to execute one or more processes; and
a memory configured to store a process that is executable by the processor, the process when executed configured to:
determine an underlay network physical topology;
determine an overlay network virtual topology in relation to the underlay network physical topology;
determine an intent for redundancy between a replication ingress point to a replication egress point within the overlay network virtual topology; and
compute a plurality of disjoint overlay paths from the replication ingress point to the replication egress point, ensuring that each of the plurality of disjoint overlay paths do not share any portion of the underlay network physical topology.

17. The apparatus as in claim 16, wherein the overlay network virtual topology comprises two independent local area networks and utilizes a Parallel Redundancy Protocol (PRP).

18. The apparatus as in claim 16, wherein the overlay network virtual topology comprises two sides of a ring topology and utilizes High-availability Seamless Redundancy (HSR).

19. The apparatus as in claim 16, wherein the process when executed is further configured to:
determine an inability to find two disjoint overlay paths; and
generate, in response to the inability to find two disjoint overlay paths a notification indicating the inability to find two disjoint overlay paths and one or more locations of required overlap.

20. A tangible, non-transitory, computer-readable medium storing program instructions that cause a device to execute a process comprising:
determining an underlay network physical topology;
determining an overlay network virtual topology in relation to the underlay network physical topology;
determining an intent for redundancy between a replication ingress point to a replication egress point within the overlay network virtual topology; and
computing, a plurality of disjoint overlay paths from the replication ingress point to the replication egress point, ensuring that each of the plurality of disjoint overlay paths do not share any portion of the underlay network physical topology.
